(19) United States
(12) Patent Application Publication
(10) Pub. No.: US 2014/0040091 A1
(43) Pub. Date: Feb. 6, 2014

(54) LOSS RISK MANAGEMENT ACROSS MULTIPLE VENUES

(71) Applicant: CFPH, LLC, New York, NY (US)

(72) Inventors: Gerard Phelan, New York, NY (US); Jacob Loveless, Boca Raton, FL (US)

(73) Assignee: CFPH, LLC, New York, NY (US)

(21) Appl. No.: 13/788,880

(22) Filed: Mar. 7, 2013

Related U.S. Application Data
(60) Provisional application No. 61/680,163, filed on Aug. 6, 2012.

(51) Int. Cl. G06Q 40/04

(52) U.S. Cl. CPC G06Q 40/04
USPC 705/37

(57) ABSTRACT

Some embodiments may relate to managing the risk of losses over a variety of risk venues. For example, a central system may monitor trading losses and profits by an entity over a plurality of exchanges. When losses exceed profits by some threshold amount, trading at the exchanges may be halted. Other example methods and apparatus are described.

### CROSS REFERENCE TO RELATED APPLICATIONS

This application claims priority to U.S. provisional application 61/680,163 filed Aug. 6, 2012, which is hereby incorporated herein by reference.

### FIELD

Some embodiments may relate to managing risk related to losses.

### BACKGROUND

An entity may risk money (e.g., through a stock exchange by buying a financial instrument such as a security). Such risks may result in losses to the entity over time (e.g., by selling a security at a lower price than it was purchased).

### BRIEF DESCRIPTION OF THE FIGURES

FIG. 1 shows an example system that may be used in some embodiments.

FIG. 2 shows an example method that may be performed in some embodiments.

### SUMMARY

The following should be understood to be embodiments, not claims.

A. An apparatus comprising: a risk manager configured to: receive reports of trading activity of a plurality of trading entities from a plurality of trading venues, calculate losses of the trading entities over time based on the reports of trading activity, and report the losses to the plurality of trading venues in substantially real time; and a trading venue of the plurality of trading venues, in which the trading venue is configured to: compare an amount of reported losses of the trading entity to a threshold amount of losses allowed for the trading entity, in which the threshold amount of losses allowed is based on an amount of collateral from the trading entity held by one or more collateral holding entities, and halt trading by the trading entity if the amount of reported losses exceeds the threshold amount of losses.

The apparatus of claim A, in which the trading entity includes a high frequency algorithmic trader. The apparatus of claim A, in which the threshold includes a plurality of thresholds that cover different amounts of time such that larger losses are allowed over larger time amounts. The apparatus of claim A, in which the trading entity includes a market maker and the one or more collateral holding entities includes clearing houses. The apparatus of claim A, in which the trading venue is configured to receive an indication that a collateral holding entity of the plurality of collateral holding entities has increase collateral held on behalf of the trading entity, and in response, allowing trading by the entity again.

B. An apparatus comprising: a trading venue configured to: determine matches between orders for financial instruments and facilitate trading based on said matches; report trading activity of a plurality of trading entities through the trading venue to a risk manager; receive a report of losses of each of the plurality of trading entities that occur through trades at the trading venue and a plurality of other trading venues; compare an amount of reported losses of a trading entity of the plurality of trading entities to a threshold amount of losses allowed for the trading entity, in which the threshold amount of losses allowed is based on an amount of collateral from the trading entity held by one or more collateral holding entities, and halt trading by the trading entity if the amount of reported losses exceeds the threshold amount of losses.

The apparatus of claim B, in which the trading venue is further configured to receive a report of collateral held on behalf of the trading venue for the one or more collateral holding entities, and calculate the threshold based on the amount.

C. A computing device comprising: a processor; and a machine readable medium having stored thereon a plurality of instructions that when executed by the processor cause the apparatus to: receive reports of trading activity of a plurality of trading entities from a plurality of trading venues; calculate losses of the trading entities over time based on the reports of trading activity; and report the losses to the plurality of trading venues in substantially real time, in which a trading venue of the plurality of trading venues is configured to: compare an amount of reported losses of a trading entity to a threshold amount of losses allowed for the trading entity, in which the threshold amount of losses allowed is based on an amount of collateral from the trading entity held by one or more collateral holding entities; and halt trading by the trading entity if the amount of reported losses exceeds the threshold amount of losses.

The apparatus of claim C, in which the trading entity includes a high frequency algorithmic trader. The apparatus of claim C, in which the threshold includes a plurality of thresholds that cover different amounts of time such that larger losses are allowed over larger time amounts. The apparatus of claim C, in which the trading entity includes a market maker and the one or more collateral holding entities includes clearing houses.

### DETAILED DESCRIPTION

### I. Example Embodiments

Losses for a trading entity may put that trading entity at risk of not being able to fulfill some of its trading obligations. Such risk may become heightened in an era of high frequency algorithmic trading where a glitch in an algorithm may cause one trading entity to very rapidly accumulate large amounts of loses and engage in large amounts of trades. A risk management solution may monitor trading activity of trading entities to prevent the trading entities from taking too many losses while still accepting more trading obligations.

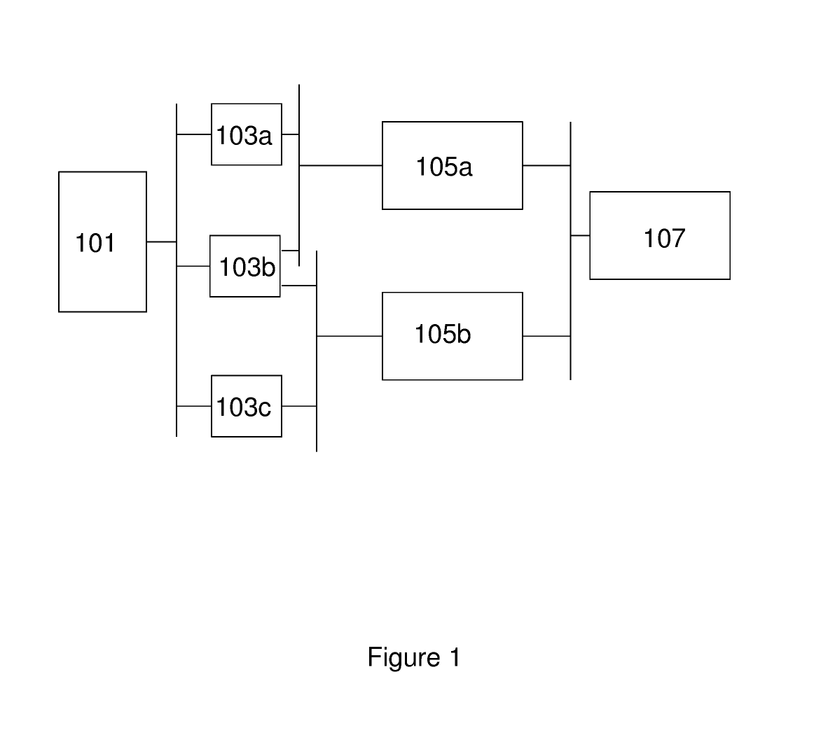

FIG. 1 illustrates an example of a set of entities that may operate together to facilitate loss risk management. FIG. 1 illustrates a trading entity 101, three collateral holding entities 103a-c, two trading venues 105a and 105b, and a risk a manager 107. These entities may operate together to allow trading activity (e.g., trading of stock, equity, bonds, debt, swaps, forwards, derivatives, securities, financial instruments, and so on as desired). These entities may operate together to allow management of loss risk by the trading entity so that the broader market is not exposed to a risk of failure of a market maker and/or other (major) trading participant in the market.

Trading entity 101 may include an entity that trades in a market for one or more financial instruments. A trading entity may include a market maker in one or more securities operating through one or more trading venues. A trading entity may include a hedge fund that may engage in trading activity through one or more trading venues. A trading entity may include a high frequency trader that may engage in trading through one or more trading venues. A trading entity may include any desired participant in any number of trading venues (e.g., a broker, a dealer, a market maker, an individual, a firm, a hedge fund, a mutual fund, a buy side participant, a sell side participant, a high frequency trader, a low frequency trade, an electronic trading system, a human trader, and so on).

A trading entity may include one or more computing devices. Such computing devices may be configured to process collateral information, receive and/or transfer funds, process trading information, communicate through a communication network, direct trading orders, and/or perform any desired actions.

A collateral holding entity may include any entity that may hold collateral on behalf of trading entity 101. For example, in the illustrated example, trading entity 101 may use three separate collateral holding entities. In one example, if trading entity 101 is a market maker, these collateral holding entities may include clearinghouses used to clear/settle trades from one or more exchanges. In another example, if trading entity 101 is a hedge fund, these collateral holding entities may include primary brokers used by the hedge fund.

In some embodiments one or more collateral holding entity (e.g., 103 a-c) may be responsible for some aspect of trading on behalf of a trading entity. For example, a collateral holding entity may place orders on an exchange for a trading entity. As another example, a collateral holding entity may engage in clearing of trades on behalf of a trading entity. A trading entity and a collateral holding entity may communicate with one another through a network. For example, a trading entity may identify that a collateral holding entity should take certain trading actions on behalf of the trading entity through a communication network (e.g., the Internet). As another example, a collateral holding entity may transmit information regarding trade completion, settlement, and so on to a trading entity through such a communication network.

In some embodiments, a trading entity may provide funds to a collateral holding entity (i.e., provide collateral). Such funds may be provided in any desired manner (e.g., electronic funds transfer, wire transfer, in cash, in the form of a security, etc.). The collateral holding entity may allow the trading entity to leverage those funds to buy and/or sell financial instruments through one or more trading venues. The trading entity may direct the collateral holding entity to make one or more trading actions on behalf of the trading entity. For example, the trading entity (e.g., a hedge fund) may direct a collateral holding entity (e.g., a primary broker) to buy and sell financial instruments as desired by the trading entity. The collateral holding entity may communicate with a trading venue to engage in such trading.

A collateral holding entity may be specific to a trading venue. As illustrated, collateral holding entity 103a is specific to trading venue 105a and collateral holding entity 103c is specific to trading venue 105b but collateral holding entity 103b is generic to both trading venues 105a and 105b. A trading entity may use any number or combination of collateral holding entities with any desired functionality that may or may not facilitate trading at any number of trading venues as desired.

A collateral holding entity may include one or more computing devices. Such computing devices may be configured to process collateral information, receive and/or transfer funds, process trading information, communicate through a communication network, direct trading orders, and/or perform any desired actions.

It should be recognized that collateral holding entities may take many different forms in many different embodiments. In some embodiments, such a collateral holding entity may not engage in trading activity related to the trading entity. For example, the collateral holding entity may simply be a bank where funds are held and the trading entity may directly engage in trading activity with a trading venue.

A trading venue 105a, b may include a venue through which financial instruments may be traded. A trading venue may include an alternative trading system, an exchange, an electronic marketplace, and/or any desired venue. A trading venue may include one or more computing devices that may be configured to receive orders, process clearing information, match orders, transfer ownership, facilitate trading, and/or perform any desired actions. A trading venue may receive buy and sell orders and match those orders together to form a trade. A trading venue may use a clearing house (e.g., one of the collateral holding entities and/or some other entity) to settle/clear a trade after finding a match. A trading venue may receive orders from a trading entity directly and/or through a collateral holding entity. For example, an exchange may accept buy and sell orders for a same security from a market maker. The exchange may find a match to one or more of those orders and may transmit that match to a clearing house for settlement of a trade embodied in the match. As another example a trading venue may receive buy and/or sell orders for any number of financial instruments from one or more brokers on behalf of some investor. The exchange may find matches for some of those orders and may facilitate trades in response to those matches.

A trading venue may report trading events to a risk manager 107 (e.g., through a communication network). In some embodiments, certain types of trades and/or trading entities may have their trades reported to the risk manager 107. A report may identify the trading entity, the side of the trade that the trading entity is on, a price of a trade, a financial instrument traded, a quantity of the financial instrument, and/or any information that may be used to track profits and/or losses through trading activity. For example, market makers, hedge funds, mutual funds, high frequency participants, large entities, and so on may have their trades reported. All entities may have their trades reported in some embodiments. In some embodiments, trading entities may opt in to have their trades reported. In some embodiments, a trading venue may opt in to make such reporting. In some embodiments, a trading venue may be required to make such reporting for all and/or certain trading entities. In some embodiments, rather than a trading venue, some other entity may make such reporting, such as a collateral holding entity, and/or a trading entity.

A risk manager 107 may include a computing device that may be configured to determine information regarding risk related to a trading entity, receive risk reports, monitor trading activity, transmit information, communicate through a communication network, and/or perform any desired actions. Risk manager may receive trading reports from trading venues. For example, risk manager may receive reports regarding the buy and sell activity on the trading venues for a trading entity. The risk manager may use such information to calculate profits and losses through trading activity for such a trading entity (e.g., over a period of time, for a period of time, for a particular day, for a particular month, as a rolling total, ongoing, from a starting date, etc.).

In some embodiments, a plurality of trading venues (e.g., all public exchanges) may report such trading activity to a risk manager. In some embodiments, a trading entity may report such activity to a risk manager (e.g., may opt in to do so, may be required to do so, etc.). Such direct reports may be instead of reports from a trading venue. Such direct reports may be in addition to such reports from a trading venue (e.g., such as for activity on private exchanges that may not otherwise have been reported).

It should be recognized that examples of reporting trading activity are given as non-limiting examples only and that a risk manager may obtain risk related information in any manner from any source in various embodiments.

In some embodiments, a risk manager may use this information to calculate profits and/or losses for each of a plurality of monitored trading entities. For example, a report may indicate purchase of some number of IBM shares at a first price and a later sale of those shares at a second price (e.g., at a same or different trading venue). The risk manager may match these trades together to determine an amount of money earned or lost by a trading entity through these trades. Multiple trades may be matched together using a FIFO, LIFO, pro-rata and/or any method for determining profits or losses as desired. In some embodiments, profits over time may be offset by losses over time to determined how much profit or loss a trading entity has made over a time period and/or from some start date. In other embodiments such offsetting may not be performed and a running loss total may be maintained that is independent of possibly offsetting profits. Such profits and/or losses may be monitored/determined over a plurality of financial instruments (e.g., all financial instruments, all publicly traded financial instruments, all reported instruments, etc.) to determine a total profit and/or loss amount for a trading entity involving those instruments.

A risk manager may report such profit and/or loss to a trading venue. Accordingly, a trading venue may know a real time and/or substantially real time profits and/or losses of some or all of its trading participants. Reports of trades and/or profits/losses may be encrypted so that they do not become public information but rather stay as a private tool used for risk management.

A trading venue may determine whether to allow a trading entity to continue trading based on the profits and/or losses of the trading entity. For example, if losses exceed some threshold, the trading venue may halt trading by the trading entity and/or require the trading entity to take some action before they continue to trade through the trading venue. In some embodiments, such halting may be specific to a financial instrument (e.g., a financial instrument for which losses exceed a threshold) and/or broadly based across all financial instruments.

A threshold may be determined for a trading entity in many different ways. For example, a threshold may be based on a credit worthiness of the trading venue and/or an amount of collateral that the trading entity has held collectively by the collateral holding entities. A trading venue may receive credit worthiness information (e.g., a focus report, credit ratings, company information, etc.) and receive collateral information (e.g., from one or more collateral holding entity) and may use that information to determine a threshold for a trading entity. A trading venue may sum the collateral from a plurality of collateral holding entities to obtain a total collateral and may use that information to determine a threshold. For example, a threshold may include 10% of collateral for a low worthiness entity, 110% for a high credit worthy entity, anywhere in between/above/below for any entity. It should be recognized that example thresholds and methods of determining such thresholds are non-limiting examples only. Some embodiments may not use such credit worthiness but may rather provide a set percentage for each trading entity or trading entity type.

Some embodiments may include various different time based thresholds. For example, a very rapid increase to losses may be treated differently than a longer term increase in losses. A very rapid increase in losses may be indicative of a rogue trader or malfunctioning trading algorithm. So, a lower threshold may be used than for a longer term loss trend. Accordingly, some embodiments may monitor trading losses in various time periods and reference those time periods to different threshold.

A threshold may include a sliding threshold of losses that increases over time, a discrete sets of thresholds that increase over time, and so on so that time and losses are related in some manner that is desired to control risk. Accordingly, in some embodiments, a cure to a threshold violation may simply amount to waiting out a threshold time limit (e.g., so that losses within a period of time from the current time do not exceed the threshold for that time period). In some embodiments, once any threshold is breached, then a collateral adjustment may be required rather than a simple waiting out of a time period even if such periods of time are used.

Some embodiments may allow a trading entity to cure a violation of a risk threshold. For example, a trading entity may cure a violation of a threshold by increasing collateral available through one or more collateral holding entity (e.g., transferring money through a wire transfer from a bank account to a collateral account). Such a collateral holding entity may report that change to a trading venue and/or risk manager. The trading venue may verify collateral levels periodically, in response to an amount of losses, in response to a reported change at any collateral holding entity, randomly, in an ongoing manner, and so on. When a trading venue is satisfied that collateral available has increased to eliminate the threshold violation, the trading venue may allow the trading entity to engage in trading again. The trading venue and/or risk manager may continue to monitor the entity for possible future threshold violations and allow further cures as they occur.

One or more elements may be connected by one or more networks. For example, one or more entities may communicate using the Internet, a dedicated network, a public network, and so on. Reports may be communicate between entities using such networks.

Accordingly, a risk management solution may prevent runaway algorithmic traders from taking on obligations that may not be fulfillable by the trader.

It should be recognized that the structure of FIG. 1 is given as a non-limiting example only. Any desired set of entities in any combined structure may be used to manage risk from losses. For example, a trading entity itself may engage in trading through a trading venue directly and may hold collateral itself. As another example, a trading venue itself may monitor profits and losses across other exchanges rather than through a risk manager. It should be recognized that while some embodiments are described in terms of a trading venue performing some risk related action and a risk manager being a separate entity, that such examples are non-limiting. For example, a risk manager may control a trading venue to halt or allow trading activity, a risk manager may be part of a trading venue, a trading venue may report collateral information to a risk manager, a trading venue may be required to receive a command to allow trading from a risk manager before a halting is cured, and/or any desired combination or arrangement of elements may be used that include some, all, or none of those described herein. .

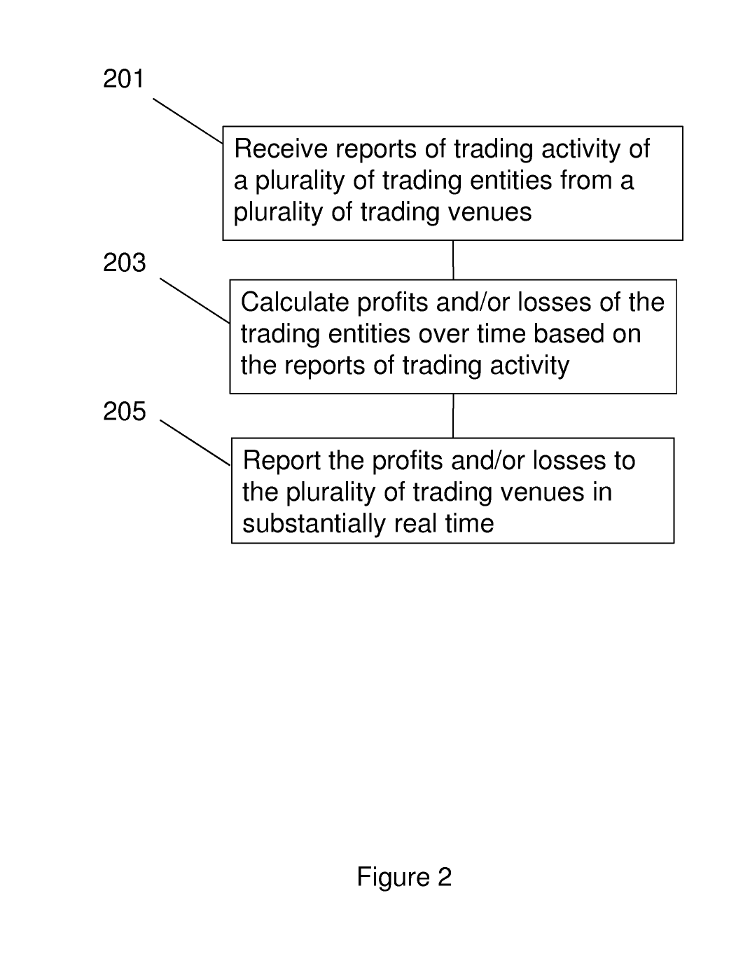

FIG. 2 illustrates an example method that may be performed in some embodiments. In some embodiments, the method of FIG. 2 may be performed by a risk manager 107 of FIG. 1. In other embodiments, some or all of such a method may be performed by a trading venue, a collateral holding entity, and/or a trading entity.

As indicated at block 201, some embodiments may include receiving reports of trading activity of a plurality of trading entities from a plurality of trading venues. An exchange may report such information in substantially real time to a risk manager. Such information may be reported through a communication network in an encrypted format.

As indicated at block 203, some embodiments may include calculating profits and/or losses of the trading entities over time based on the reports of trading activity. For each trading entity, a risk manager may calculate offsetting trades that cause a loss or profit to the trading entity. Such trades may occur at different exchanges from one another (e.g., a buy of a stock at one exchange and a later sale of the stock at a different exchange may be used to determine losses or profits from the stock). For each trading entity a risk manager may sum such profits and losses to determine a running profit or loss amount over time in substantially real time. Some embodiments may include an ongoing profits or loss amount. Some embodiments may include profits or loss amounts for specific periods of time (e.g., last hour, last minute, last ten minutes, last 30 seconds, last day, last week, last month, etc.)

As indicated at block 205, some embodiments may include reporting the profits and/or losses to the plurality of trading venues in substantially real time. Such information may be reported in substantially real time over a communication network in an encrypted format. Such reporting may allow the trading venues to monitor trading loss risk of its participants. The exchange may use that information to halt trading if the losses exceed a threshold for a specific entity being monitored.

It should be recognized that the example of FIG. 2 is given as a non-limiting example only. Other embodiments may include any actions in any order performed by any entity.

When a trading entity is referenced, it should be recognized that such an entity may include more than one entity with a legal association that may allow them to be treated as one entity. Similarly, a single trading entity may actually be treated as different entities as desired. For example, a high frequency trader may trade using a set of algorithms and each algorithm may be treated as a different entity (or all as s single entity).

In some embodiments, a collateral reporting may be done to a risk manger rather than and/or in addition to a trading venue. In some embodiments, a risk manager may perform actions to halt trading rather than a trading venue. For example, a risk manager may direct a trading venue to not accept trades from a trading entity because of a threshold violation by the trading entity. In such an embodiment, trading venues may offload the risk management functionality to the risk manager. For example, the risk manager may determine the threshold or use a threshold identified by the trading venue to command halting of trading.

Although some embodiments are described with reference to halting trading, it should be recognized that such an action is given as a non-limiting example only. For example, some embodiments may halt only certain types of transactions (e.g., large transactions, buy transactions, transaction in a particular financial instrument or type of instrument, etc.). In some embodiments, there may be multiple threshold, so that certain transactions are halted for certain thresholds (e.g., a first threshold may halt large transactions and a second threshold may halt all transactions). Accordingly, trading by an entity may continue while the entity is on a risk watch. This may allow the entity further ability to avoid full halting while minimizing risk to a market.

A trading entity may be notified of a watch and/or halting status. Some embodiments may include reporting threshold information to a trading entity so that the trading entity knows of the violation and/or potential upcoming violations so that it can prevent and/or cure the violations. For example, a trading venue may identify that a trading entity is 90% towards a threshold and should take action to prevent a halting.

Although various embodiments are described as being related to exchanges or traditional trading venues, it should be recognized that such embodiments are non-limiting examples only. For example, such a system may be used in a wagering exchange or other wagering environment to monitor losses of a particular wagerer or wager trader. For example, if a wagerer takes on too many losses by losing wagers, the wagerer may be required to increase collateral available to make wagers. In another example, if a gaming operator that traders wagers through a wager exchange losses too many wagers (or takes trading losses in the trading of wagers), the gaming operator may be required to increase collateral before engaging in further wager trading.

It should be recognized that various embodiments may further apply to any exchange environment, any environment where money is risked on some possible future event, and so on.

The following sections provide a guide to interpreting the present application.

### II. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term.

Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., , 2, 3, 4, . . . ) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### III. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology Are Not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components / features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non- simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth□, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VII. Continuing Applications

The present disclosure provides, to one of ordinary skill in the art, an enabling description of several embodiments and / or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VIII. 35 U.S.C. §112, paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### IX. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### X. Incorporation By Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### XI. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XII. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

What is claimed is:

1. An apparatus comprising:
a risk manager configured to:
receive reports of trading activity of a plurality of trading entities from a plurality of trading venues,
calculate losses of the trading entities over time based on the reports of trading activity, and
report the losses to the plurality of trading venues in substantially real time; and
a trading venue of the plurality of trading venues, in which the trading venue is configured to:
compare an amount of reported losses of the trading entity to a threshold amount of losses allowed for the trading entity, in which the threshold amount of losses allowed is based on an amount of collateral from the trading entity held by one or more collateral holding entities, and
halt trading by the trading entity if the amount of reported losses exceeds the threshold amount of losses.

2. The apparatus of claim 1, in which the trading entity includes a high frequency algorithmic trader.

3. The apparatus of claim 1, in which the threshold includes a plurality of thresholds that cover different amounts of time such that larger losses are allowed over larger time amounts.

4. The apparatus of claim 1, in which the trading entity includes a market maker and the one or more collateral holding entities includes clearing houses.

5. The apparatus of claim 1, in which the trading venue is configured to receive an indication that a collateral holding entity of the plurality of collateral holding entities has increase collateral held on behalf of the trading entity, and in response, allowing trading by the entity again.

6. An apparatus comprising:
a trading venue configured to:
determine matches between orders for financial instruments and facilitate trading based on said matches;
report trading activity of a plurality of trading entities through the trading venue to a risk manager;
receive a report of losses of each of the plurality of trading entities that occur through trades at the trading venue and a plurality of other trading venues;
compare an amount of reported losses of a trading entity of the plurality of trading entities to a threshold amount of losses allowed for the trading entity, in which the threshold amount of losses allowed is based on an amount of collateral from the trading entity held by one or more collateral holding entities, and
halt trading by the trading entity if the amount of reported losses exceeds the threshold amount of losses.

7. The apparatus of claim 6, in which the trading venue is further configured to receive a report of collateral held on behalf of the trading venue for the one or more collateral holding entities, and calculate the threshold based on the amount.

8. A computing device comprising:
a processor; and
a machine readable medium having stored thereon a plurality of instructions that when executed by the processor cause the apparatus to:
receive reports of trading activity of a plurality of trading entities from a plurality of trading venues;
calculate losses of the trading entities over time based on the reports of trading activity; and
report the losses to the plurality of trading venues in substantially real time, in which a trading venue of the plurality of trading venues is configured to: compare an amount of reported losses of a trading entity to a threshold amount of losses allowed for the trading entity, in which the threshold amount of losses allowed is based on an amount of collateral from the trading entity held by one or more collateral holding entities; and halt trading by the trading entity if the amount of reported losses exceeds the threshold amount of losses.

9. The apparatus of claim 8, in which the trading entity includes a high frequency algorithmic trader.

10. The apparatus of claim 8, in which the threshold includes a plurality of thresholds that cover different amounts of time such that larger losses are allowed over larger time amounts.

11. The apparatus of claim 8, in which the trading entity includes a market maker and the one or more collateral holding entities includes clearing houses.
